(19) United States
(12) Patent Application Publication
(10) Pub. No.: US 2015/0052032 A1
(43) Pub. Date: Feb. 19, 2015

(54) TRANSACTIONAL MESSAGING SYSTEMS AND METHODS

(71) Applicant: Seergate Ltd., Raanana (IL)

(72) Inventor: Eldad AHARONI, Ra'anna (IL)

(21) Appl. No.: 14/460,527

(22) Filed: Aug. 15, 2014

Related U.S. Application Data
(60) Provisional application No. 61/866,056, filed on Aug. 15, 2013.

(51) Int. Cl. G06Q 40/00; G06F 3/0481; H04L 12/24; G06F 17/30; H04L 12/58

(52) U.S. Cl. CPC G06Q 40/12; G06F 17/30091; H04L 51/04; H04L 41/22; G06F 3/04817
USPC 705/30

(57) ABSTRACT

A transactional messaging system displaying financial transactions in a user interface structured to resemble an email messaging user interface and/or an instant messaging user interface. The financial transactional messaging system presents and interacts with the financial transactions as email or instant messages, reducing the complexity of tracking, managing and processing transactions while preserving the full capabilities of a transaction processing system. Different transactions scenarios, such as requesting money, sending money, refunding a payment, sending payouts, cash on delivery (COD) and other financial transactions are presented utilizing different transactional process types that are organized under different mailbox folders such as inbox, sent items and deleted items. Inside each folder, the different transactions appears as emails that can be read, processed (pay, accept, release funds, decline, etc.) and/or with graphical elements like icons reflecting the current transaction attributes such as state or the actual activity performed by the transaction on the user's account. Relationships between a user selected transaction and the parties involved in the transaction in the role of payee or payor, are illustrated using email based schemes such as sender/recipient that focus on the selected transaction to avoid confusion due to information overload.

### CROSS-REFERENCE TO OTHER APPLICATIONS

This applications claims priority according to the Paris Convention from U.S. Provisional Application No. 61/866,056 filed on Aug. 15, 2013 and incorporated herein by reference.

### BACKGROUND

Financial transactions are treated in conventional payment processing interfaces as single tasks within an electronic report. This data model addresses single, standalone, one way payments effectively. However, electronic transactions are not simple standalone payments, or simple one way money movement. A given transaction is often part of a “conversation”, an interrelated series of events finalized with a payment or funds movement, resembling parties messaging each other.

While some indication of prior information may be provided in conventional transactional systems, the user interfaces do not present the user a visually user-friendly representation of the transactions as an email trail or messaging format that includes an intuitive way for any email user to read, interact, process, track and manage transactions, complex as simple.

An email messaging structure is logically formed by transactions electronically delivered between parties. Typically, a sender sends a transaction, whether requesting a payment or sending money, to a set of recipients, which may reply to that transaction positively, building a tree of messages, resembling an email messaging interface effectively, in some transactions the number of interactions required exceed the regular receive and reply interaction and the email messaging structure is more significant for efficient management. Building a user interface to display all these transactions as email messages and potentially their relationships to other transactions is not an easy task, especially as the complexity of transactional systems surpasses those of regular mailing systems and the potential scenarios of statuses, transactional data and parameters, exceptions and processing tasks exceed significantly those of plain messages.

### SUMMARY OF THE INVENTION

Embodiments aim at providing intuitive ways for users to read, process, track and manage financial transactions. A user interface is provided for displaying transactions as emails effectively by utilizing the mailbox structure of email messaging systems. Different attributes such as status, level of importance or relationships between messages are also displayed in an efficient manner utilizing graphic elements, color schemes and text.

The above and additional features and capabilities will become clear in the following description and associated drawings thereof. It is to be understood that both the foregoing general description and the following detailed description are explanatory only and are not restrictive of aspects as claimed.

The present invention thus relates to a method to be executed at least in part in a computing device comprising a processor and memory for providing a user interface that displays financial transactions as email messages, the method comprising: receiving, sending, forwarding and/or creating financial transactions within a user interface resembling a standard a email messaging user interface and/or an instant messaging user interface; determining the folder associated with the received, sent, forwarded and/or created transaction, wherein transactions created and sent are organized under the folder predefined for sent items, transactions received are organized under the folder predefined for received items, transactions cancelled or deleted are organized under the folder predefined for cancel and deleted items, all transactions can be accessed also under a general folder for all transactions, transactions that correspond to a search parameter are organized under the folder predefined for search results and transactions that comply with a manual or automatic created rule are organized under the predefined folder for said rule, the rule comprising a plurality of attributes and properties among the options presented in the user interface, such as Sender details, transaction number or ID, description key words, dates, level of importance and more. The method comprising a plurality of elements, presented in the user interface, determining the status, the level of importance and/or other attributes of a transaction, such as status icons besides the header or title of each transaction, different icon and/or header colors for example resembling debit/credit transactions using red/green colors, textual descriptors within the transaction body and/or on the header, such as completed/pending/canceled, and more. The method also comprising displaying the transactions within the user interface by presenting each transaction as an email message according to a selected or automatically generated order and within a mailbox folders structure resembling an email messaging interface visually, wherein each transaction includes a sender and recipient associated with the transaction, a header as a title, a time of creation and a time of status change and/or receipt, and a portion of body of the message that includes the transaction parameters such as transaction number or ID, reason, description and/or note, detailed information on the services and/or goods associated with the transaction, names, addresses and email addresses of the parties and more. The method also comprising that attributes and/or properties attributed to each transaction, such as title, status, level of importance, default folder, relationship to other transactions, processing rules such as due date, delayed processing and more, may be determined by applying automatic methods, or manually by the user, or alternatively by the originator of the initial transaction, or by an administrator with the option to set attributes and properties to transactions.

In some embodiments, the transactions are presented within each folder according to any of: a chronological order, sorted by senders or recipients names or emails in ascending or descending order, according to the transactions' amounts in ascending or descending order, according to transaction due date in ascending or descending order, sorted by status in any order, sorted according to a set of attributes and/or properties attributed to the transactions, organized manually by the user or by applying automatic rules that determine how transactions are organized.

In some embodiments, the header of each transaction is determined through at least one of: explicit definition and derivation from a subject line of the originating transaction, the reason included within the transaction text, the status of the transaction, the sender or recipient information or other transaction parameter.

In some embodiments, the level of importance of a given transaction is determined based on one of: user selection of a transaction parameter either by writing it within a field, user click, mouse-over or focusing of a cursor on a transaction parameter, automatic selection according to prior recurrence of a transaction, its amount or other parameter, and the level of importance is graphically presented with at least one of: a color scheme, a graphic scheme, an indentation scheme, a shading scheme, level icons.

In some embodiments, a relationship between transactions is determined automatically based on common characteristics such as sender and/or recipient, key words, amount, due date, or manually chosen by the user and such relationship is graphically presented with at least one of: a color scheme, a graphic scheme, an indentation scheme, a shading scheme, a graphic connector between the transactions.

In some embodiments, the graphical presentation of the relationship between transactions is used to provide additional information associated with at least one of: transaction parameters, transaction statuses, and relationship type.

In some embodiments, the graphic element used to indicate the transaction status includes at least one of the following: an icon, a color representing the transaction direction such as debit or credit from the user's account, an arrow to further represent the transaction direction, and a text descriptor of the status.

The present invention further relates to a computing device capable of executing an application for providing an user interface that displays transactions as email messages, the method comprising: receiving and/or creating and sending a new transaction within an electronic messaging mailbox interface, resembling a standard emailing interface; determining the folder associated with the received and/or created transaction, wherein transactions created and sent are organized under the folder predefined for sent items, transactions received are organized under the folder predefined for received items, transactions cancelled or deleted are organized under the folder predefined for cancel and deleted items, all transactions can be accessed also under a general folder for all transactions, transactions that correspond to a search parameter are organized under the folder predefined for search results and transactions that comply with a user created rule are organized under the user defined folder for said rule, the rule comprising a plurality of parameters selected by the user among the options presented in the user interface, such as Sender details, transaction number or ID, description key words, dates and more. The application also comprising a plurality of elements, presented in the user interface, determining the status of the transaction, such as status icons besides the header of each transaction, different icon and/or header colors resembling financial transaction statuses such as debit/credit transactions using red/green colors, status descriptor within the transaction and/or within the header, such as completed/pending/canceled, and more. The application also comprising displaying the transactions within the user interface by presenting each transaction as an email message according to a selected order and within a mailbox folders structure resembling an email messaging interface visually, wherein each transaction includes a sender and recipient associated with the message, a header as a title, a time of creation and a time of status change and/or receipt, and a portion of body of the message that includes the transaction parameters such as transaction number or ID, reason, description and/or note, detailed information on the services and/or goods associated with the transaction, names, addresses and email addresses of the parties and more.

In some embodiments, the transactions are presented within each folder according to any of: a chronological order, sorted by senders or recipients names or emails in ascending or descending order, according to the transactions' amounts in ascending or descending order, according to transaction due date in ascending or descending order, sorted by status in any order.

In some embodiments, the header of each transaction is determined through at least one of: explicit definition and derivation from a subject line of the originating transaction, the reason included within the transaction text, the status of the transaction, the sender or recipient information or other transaction parameter.

In some embodiments, the level of importance of a given transaction is determined based on one of: user selection of a transaction parameter either by writing it within a field, user click, mouse-over or focusing of a cursor on a transaction parameter, automatic selection according to prior recurrence of a transaction, its amount or other parameter, and the level of importance is graphically presented with at least one of: a color scheme, a graphic scheme, an indentation scheme, a shading scheme, level icons.

In some embodiments, a relationship between transactions is determined automatically based on common characteristics such as sender and/or recipient, key words, amount, due date, or manually chosen by the user and such relationship is graphically presented with at least one of: a color scheme, a graphic scheme, an indentation scheme, a shading scheme, a graphic connector between the transactions.

In some embodiments, the graphical presentation of the relationship between transactions is used to provide additional information associated with at least one of: transaction parameters, transaction statuses, and relationship type.

In some embodiments, the graphic element used to indicate the transaction status includes at least one of the following: an icon, a color representing the transaction direction such as debit or credit from the user's account, an arrow to further represent the transaction direction, and a text descriptor of the status.

In another aspect, the present invention relates to a computer-readable storage device with instructions stored thereon for providing an user interface that displays transactions as email messages, the user interface comprising: receiving and/or creating and sending a new transaction within an electronic messaging mailbox interface, resembling a standard emailing interface; determining the folder associated with the received and/or created transaction, wherein transactions created and sent are organized under the folder predefined for sent items, transactions received are organized under the folder predefined for received items, transactions cancelled or deleted are organized under the folder predefined for cancel and deleted items, all transactions can be accessed also under a general folder for all transactions, transactions that correspond to a search parameter are organized under the folder predefined for search results and transactions that comply with a user created rule are organized under the user defined folder for said rule, the rule comprising a plurality of parameters selected by the user among the options presented in the user interface, such as Sender details, transaction number or ID, description key words, dates and more. The user interface also comprising a plurality of elements, presented in the user interface, determining the status of the transaction, such as status icons besides the header of each transaction, different icon and/or header colors resembling financial transaction statuses such as debit/credit transactions using red/green colors, status descriptor within the transaction and/or within the header, such as completed/pending/canceled, and more. The user interface also comprising displaying the transactions within the user interface by presenting each transaction as an email message according to a selected order and within a mailbox folders structure resembling an email messaging interface visually, wherein each transaction includes a sender and recipient associated with the message, a header as a title, a time of creation and a time of status change and/or receipt, and a portion of body of the message that includes the transaction parameters such as transaction number or ID, reason, description and/or note, detailed information on the services and/or goods associated with the transaction, names, addresses and email addresses of the parties and more.

In some embodiments, the transactions are presented within each folder according to any of: a chronological order, sorted by senders or recipients names or emails in ascending or descending order, according to the transactions' amounts in ascending or descending order, according to transaction due date in ascending or descending order, sorted by status in any order.

In some embodiments, the header of each transaction is determined through at least one of: explicit definition and derivation from a subject line of the originating transaction, the reason included within the transaction text, the status of the transaction, the sender or recipient information or other transaction parameter.

In some embodiments, the level of importance of a given transaction is determined based on one of: user selection of a transaction parameter either by writing it within a field, user click, mouse-over or focusing of a cursor on a transaction parameter, automatic selection according to prior recurrence of a transaction, its amount or other parameter, and the level of importance is graphically presented with at least one of: a color scheme, a graphic scheme, an indentation scheme, a shading scheme, level icons.

In some embodiments, a relationship between transactions is determined automatically based on common characteristics such as sender and/or recipient, key words, amount, due date, or manually chosen by the user and such relationship is graphically presented with at least one of: a color scheme, a graphic scheme, an indentation scheme, a shading scheme, a graphic connector between the transactions.

In some embodiments, the graphical presentation of the relationship between transactions is used to provide additional information associated with at least one of: transaction parameters, transaction statuses, and relationship type.

In some embodiments, the graphic element used to indicate the transaction status includes at least one of the following: an icon, a color representing the transaction direction such as debit or credit from the user's account, an arrow to further represent the transaction direction, and a text descriptor of the status.

### BRIEF DESCRIPTION OF THE DRAWINGS

FIG. 1 illustrates a conceptual diagram of transactions presented in a mailbox structure following an email messaging system structure;

FIG. 2 is another conceptual diagram illustrating one possible embodiment of the different folders, the transactions within each and their respective statuses following an email messaging system structure;

FIG. 3 illustrates a standard transaction processing user interface;

FIG. 4 illustrates an example of the user interface according one embodiment of the present invention, resembling an email messaging user interface;

FIG. 5 illustrates an user interface, according to embodiments of the present invention, displaying transactions and the importance of each within an interface resembling an email messaging system;

FIG. 6 illustrates an user interface according to embodiments of the present invention displaying a new transaction created over a mobile screen with the option to be sent to a recipient;

### DETAILED DESCRIPTION

As briefly described above, transactions may be presented in an intuitive way for user to read and interact resembling an email messaging system format. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computer device, embodiments may also be implemented in combination with other program modules, in interaction with multiple application programs, as cloud service as well as on a mobile device.

Embodiments may be implemented with different system configurations, including hand-held devices, multiprocessor systems, microprocessor-based or programmable consumer electronics, minicomputers, mainframe computers, and any electronic device capable of delivering the user experience to the user. Embodiments may also be implemented over distributed computing environments where tasks are performed by remote processing devices that are linked through a communications network. In a distributed computing environment, program modules may be located in both local and remote memory storage devices. By way of example, and not limitation, communication media includes wired media such as a wired network or direct-wired connection, and wireless media such as acoustic, RF, infrared and other wireless media.

Embodiments may be implemented as a computer process (method), a computing system, or as an article of manufacture, such as a computer program product or computer readable media, all comprising a processor and memory. The computer program product may be a computer storage media readable by a computer system and encoding a computer program of instructions for executing a computer process.

The claimed subject matter also includes methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

The term ‘transaction’ as used herein includes electronic financial transactions system objects like payment requests, money transfers, refunds, payouts, group payment collection, bill payments, and any other message of financial or money movement nature, as well as a number of other artifacts that may appear to be part of how a financial transaction may be modeled. For example, based on a payment request transaction received one may negotiate a payment. The process of negotiating the payment may involve multiple iterations between senders and recipients accepting or rejecting the terms proposed, as well proposing new terms instead. Some embodiments may consider the negotiation/accept/reject objects as “transactions”. Additionally, some financial transactions may require the exchange of agreements or contracts prior to money movement, the documentation resulting from such exchange, as well as the electronic signature of such, may be considered as “transactions” by some embodiments.

The above specification, examples and data provide a description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

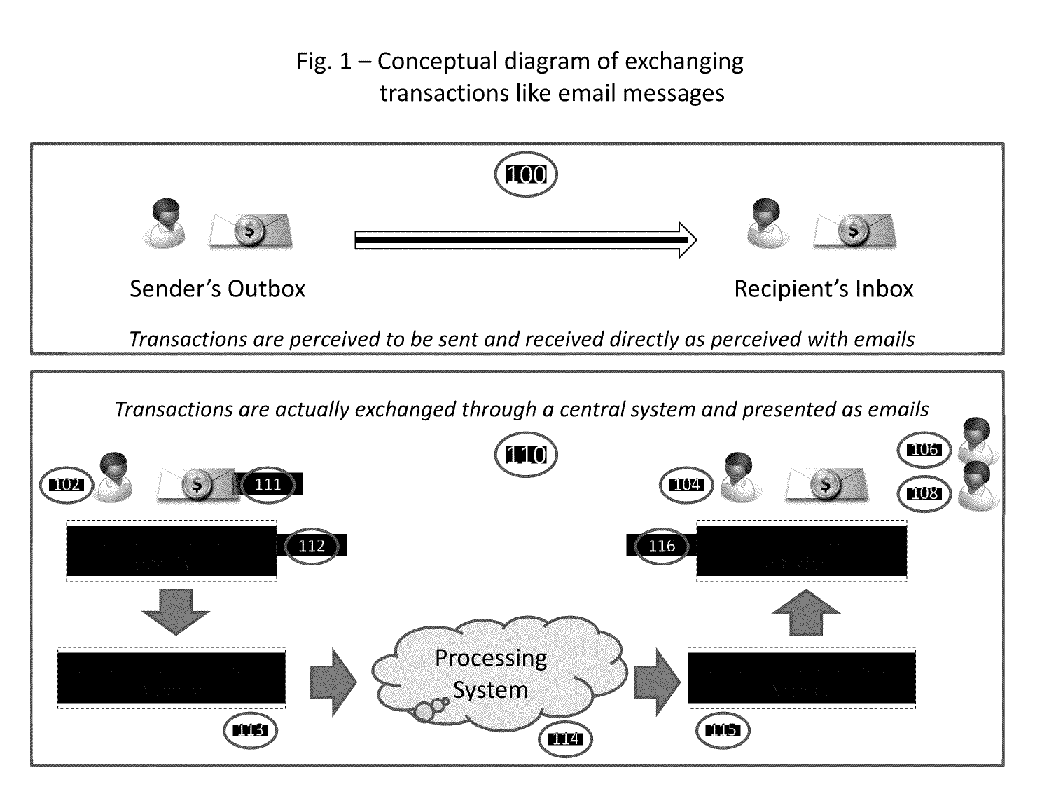

Referring to FIG. 1, a conceptual diagram of exchanging transactions like email messages, is illustrated. Diagram 100 shows how a transaction appears as being sent directly from one user to another directly as perceived in email messaging systems, while diagram 110 shows how actually transactions are transmitted as in an email messaging system model with two users exchanging transactions. The transactions exchanged between users 102 and 104 may include a payment request, a money transfer, a payout, a refund, a transaction agreement, an attached document including images, graphics, sound or text, and/or the processing of any of the aforementioned transactions (111). The transaction is created within, or retrieved into, the user's mailbox (112), is then stored within the user's authenticated account (113) and processed through a central system (114) for transmission to one user or multiple others (e.g. user 102 to user 104 or users 106 and 108 and their respective mailboxes). Each transaction is received by the recipient's authenticated account (115) and presented to the recipient though the recipient's mailbox (116). Responses to the original transaction, in the form of a payment, a transfer acceptance, a decline or other responses, may be received from different parties, which themselves may be sent to all participants or to the originator. Thus, the exchanged transactions may have a complicated structure, while all together representing financial transactions between the participants (users 102, 104, 106) resembling the exchange of email messages.

In a system according to embodiments, not all transactions that are part of the same transaction flow need to be stored in the same folder because the folder structure may group the transactions differently. For example, a folder hierarchy may have a folder for invoices paid by clients, and another for refunds made to a client for a paid invoice. A transaction may be a payment request or invoice followed by a series of partial payments. Furthermore, the transaction itself may have properties (e.g. a description of the transaction, a transaction number or id, the transaction status, or correspond to a user-generated rule to be stored within a predetermined folder). Thus, a full transaction cycle may include transactions stored in a single folder, multiple folders or multiple times under several folders.

According to other embodiments, a variety of techniques may be employed to organize transactions related to other transactions under a folder structure that reflects such relationships. According to further embodiments the relationship between transactions may be automatically established by the system, generated by the user or, when a transaction is received into the user interface, it may include an indication of its relationship to other transactions.

As with conventional email systems, transactions may be organized under categories in the form of folders according to an attribute and/or property attributed to each transaction, or by applying automatic rules that determine different categories according to which transactions are organized, or manually by the user or alternatively by the originator of the initial transaction or an administrator with the option to set attributes and properties to transactions (e.g. title, default folder, importance level, etc.). For example, a category may be the sender name or the type of transaction, presenting different categories that apply to the same transaction.

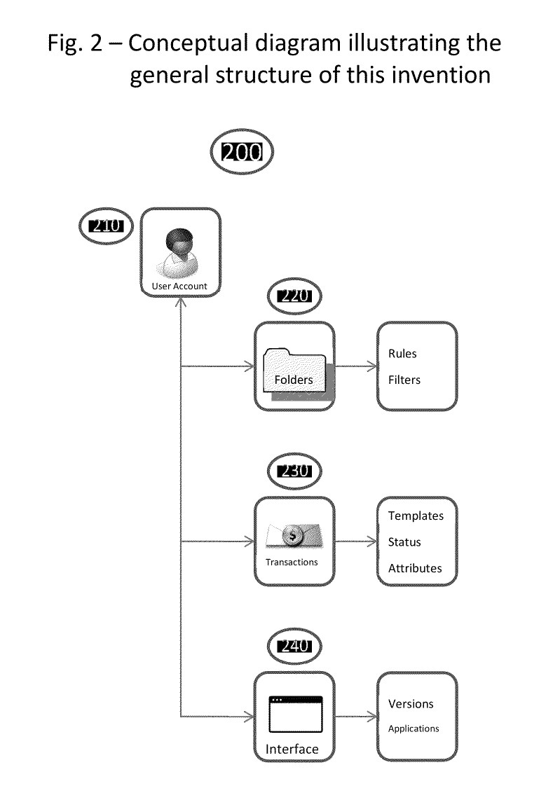

FIG. 2 is another conceptual diagram (200) illustrating the general structure of this invention resembling the standard structure of an email messaging interface according to one possible embodiment. The user interface may present many optional capabilities such as scheduling transactions, automatic processing of transactions, customizable templates for new transaction creation, a risk filtering method for marking transactions as high risk and others.

As a structured aggregation of transactions under user account (210), folders (220) provide categorized storage for the transactions (230), utilizing rules and filters as well as other methods. As mentioned previously, each transaction (230) may be stored under a single or several folders at once and there may be a relationship between several transactions for various reasons, including automatic as well as manual relationship discovery. Transactions (230) are initiated, utilizing templates, or received, through the user account (210) and displayed via the user interface (240). Transactions (230) may be displayed following differing arrangements and sorting methods, including level of importance, chronological and more. Transactions (230) are associated with statuses that may vary over time, the same way that email messaging interfaces apply statuses to emails as read or unread, but transaction (230) statuses are numerous and have complex mechanisms behind their application to specific transactions (230).

User account (210) also interacts with user interface (240) presenting the transactions (230) so that a user can easily determine the status, the importance and the relationship between transactions. Transaction (230) properties such as status, importance and relationship may be presented visually combined for a user-friendly display.

Transactions (230) may have additional attributes that may include properties that can be associated with predetermined folders (220) or other transactions (230). Examples of such attributes include a default folder (220) for the transaction (230), a “delayed” attribute (keeping a transaction (230) invisible or inaccessible until a specific date), a list of users to be associated with the transaction (230) under certain circumstances such as payment failure by first user that triggers forwarding the transaction (230) to another user in the queue, the transaction ID of the first transaction (230) related to the current transaction (230), a list of participants in the transaction (230), and more.

The user interface (240) may be displayed according to different versions, such as desktop computer version, smartphone version, mobile device version and more. The user interface (240) may also be presented within third party applications or via its own applications such as smartphone applications, desktop computer client applications or web applications, as well as interact with external application for exchanging transactions.

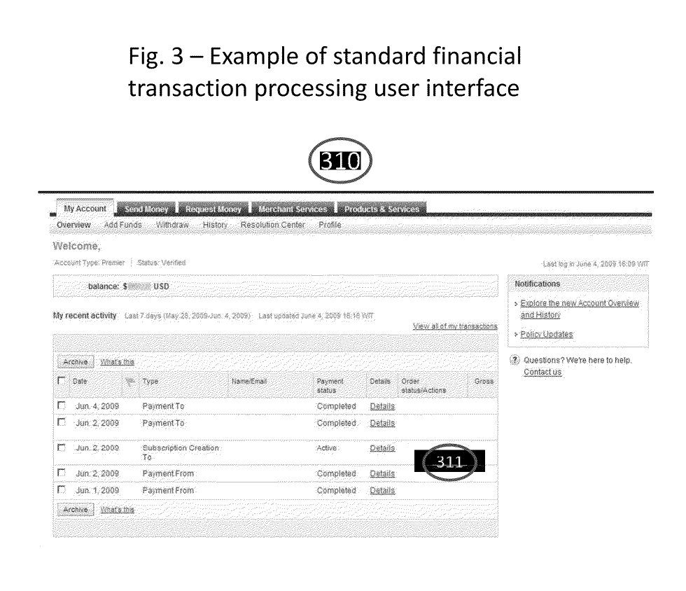

FIG. 3 illustrates an example of a standard transaction processing user interface.

A standard user interface (310) allow users to navigate through transactions listed on the screen (311) but fail to organize the transactions according to their messaging properties as became standard for email messages, i.e. folder for received transactions of any type, folder for sent transactions of any type, folder for transactions of a specific type sent or received, folder for transactions that follow certain rules, folder for transactions from certain users, graphic representation of related transactions, graphic representation for transaction′ status (as read and unread in emails), folder for transactions deleted or declined, and more. Furthermore, if additional information about each transaction is required in order to understand its importance or relationship to other transactions, such as a portion of the content, subject line, participant names, etc., the user interface becomes too complex to allow tracking and managing transactions, and the user may lose time trying to perform simple tasks.

User interface (310) lacks any information about the importance of transactions and the potential relationship between transactions. Furthermore, any attempt to respond to review the transaction in detail will require navigating away from the management screen. Also, activities do not resemble an email messaging flow and do not follow a messaging interactivity between a sender and a recipient. Transactions (311) are listed with time, type, originator, status and in some cases a portion of the content for each transaction. In this example, transactions are ordered chronologically. However, it is not possible to easily determine from the user interface, which transaction is awaiting action, which is important, which transactions are related and which transactions are under a specific category the user decided to review separately.

User interface (310) resembles a simplified accounting report with some additional functionality inherent of electronic environments.

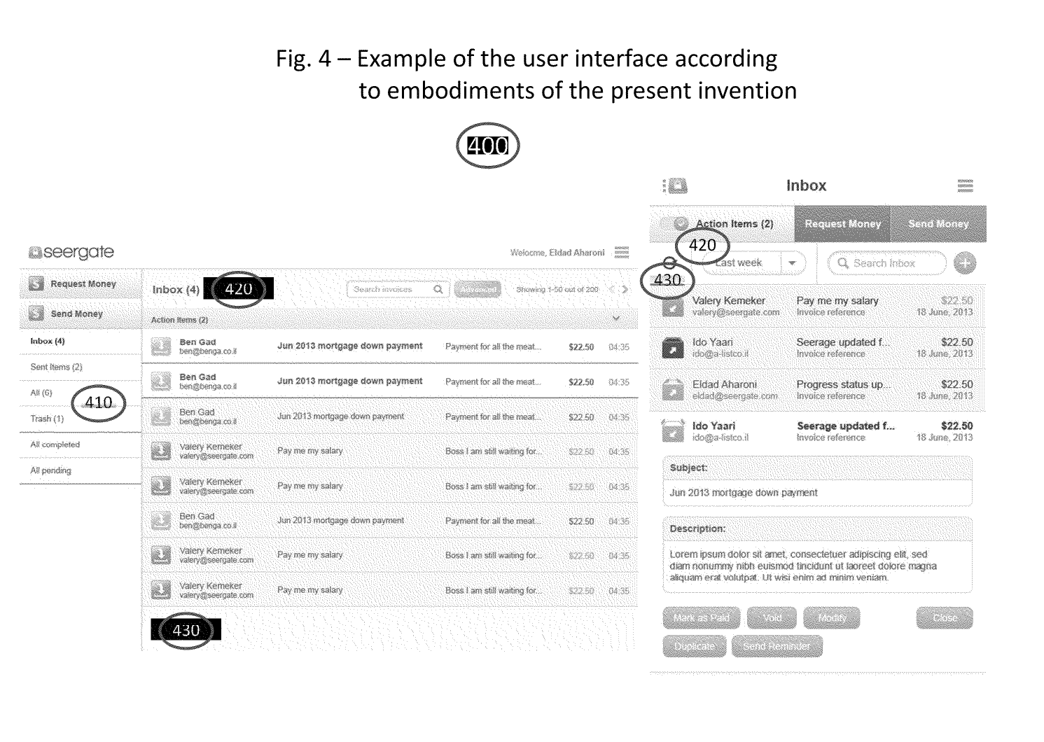

FIG. 4 illustrates an example of one embodiment of the present invention, a transaction processing user interface displaying transaction as email messages. User interface (400) is an example of an embodiment of the present invention. Folder structure (410), visual indication of unprocessed transaction resembling unread emails (420), a clear color scheme, as well as icons (430) are used to present organized and valuable information at the same time. Folders may include standard received, sent and deleted items folders as well as more sophisticated folders for transactions under certain classifications, including awaiting processing, declined or risk level, folders for the transactions returned by a search query or that respond to the classification of spam, and more. Graphical elements may include for example an icon with an incoming arrow may represent a transaction crediting money to the user's account, the color red may be utilized to reflect a transaction that debited funds from the account and the color green to reflect a transaction that credited funds into the user's account. Additional icons, color schemes, text and shadow schemes may be utilized for clearly displaying the transaction attributes, such as status, level of importance or its relation to other transactions, among other attributes.

Moreover, a user is more likely to figure out how to utilize this interface without any further assistance and/or training because of its familiarity with email messaging interfaces. Thus, the inherent complexity of transaction processing is likely to become simpler and easier to manage for the user utilizing an embodiment of the present invention and facilitate more efficient and effective processing of financial transactions.

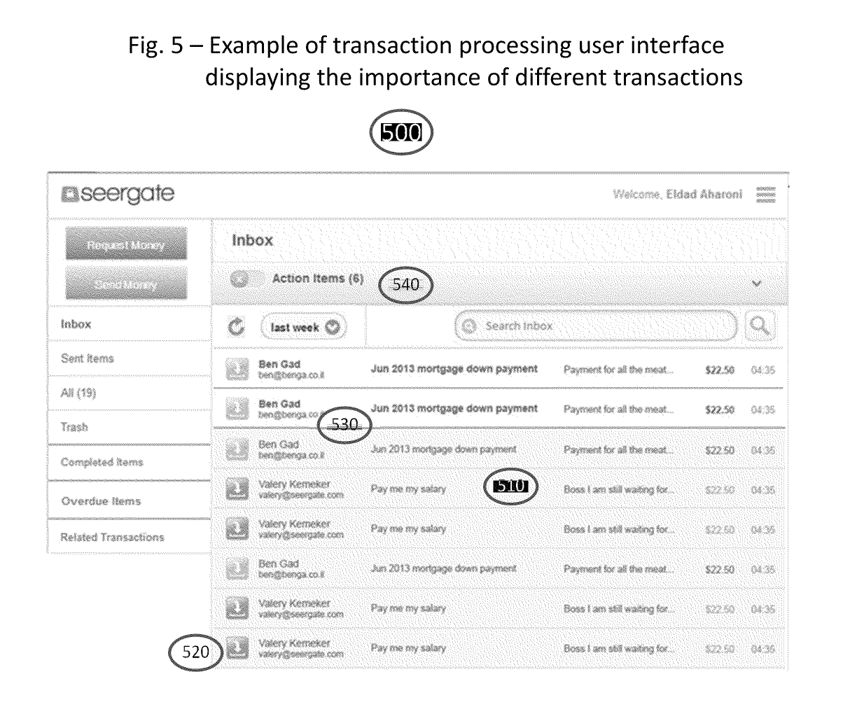

FIG. 5 illustrates a transaction processing user interface according to embodiments of the present invention, displaying the importance of different transactions. As discussed above, conventional user interfaces either provide little to no information about the importance of transactions as compared to other transactions, or provide an overabundance of information causing confusion or inability to efficiently track and manage transactions.

A user interface according to embodiments of the present invention provides visual indications about the transactions that standout due to their importance as well as the most informative pieces of information to display to the user, allowing the user to quickly prioritize transaction processing activities while keeping the user interface simple and intuitive. Such a user interface (e.g. user interface 500) may display all of the transactions in a given order, such as chronological or alphabetical, one after another, within the a scrollable table, but yet transactions that are attributed a certain level of importance, either automatically by certain applied rules, manually by the user or alternatively by the originator of the initial transaction or an administrator with the option to set attributes and properties transactions (e.g. title, default folder, importance level, etc.), will be displayed distinctive and easily recognized as more important or different from other transactions. Each row in the list, where rows may be composed by multiple lines, corresponds to a transaction (510) and displays the most important information of the transaction, different visual elements such as highlighted status icons (520), differentiating shadows (530), filtering buttons (540), color schemes and more aim at bringing the user's attention to certain transactions according to their importance and prevent overlooking the transactions that are more critical to the user's business. Transactions may also be sorted by the level of important in decreasing or increasing order. The ordering approach minimizes the time spent by the user in prioritizing transaction processing.

If the user selects a particular transaction, the user interface 500 displays the full transaction information within the same user interface.

When a transaction is processed by any party, any attribute affected by such processing, for example status or level of importance, may be updated within the user interfaces of all related parties to the transaction.

One aspect of the user interface enables a user to review related transactions in an optimized fashion. In embodiments, when the user selects a transaction that is related to other transactions, displaying the tree of transactions related to a transaction of interest only in a relatively small portion of the user interface prevents confusion due to overload of complex information, multitude of graphical elements, and data flow. The relationship between transactions may be presented in different ways such as on the mailbox structure as a special folder, on the transaction title or header as an icon, link or text indication, over the displayed transactions (using transparent graphical elements), or other color/graphical/textual schemes.

In order to maintain the user interface focused on the transactions of interest and prevent lack of focus and confusion due to overload of information and graphic elements, how the messages are displayed may also be determined based on the level of importance or the relationships of the transactions. For example, for transactions that are related only content that is unique to each transaction may be displayed, in other example information required to make a decision may be presented in bold or other graphical or color scheme. Embodiments are not limited to these examples. Other simplification and focusing approaches may be implemented using the principles described herein along with the graphic, color, and other schemes for representing level of importance and relationships between transactions within the user interface.

In addition to the transaction display related parts, the financial transactions user interface (500) may include selectable controls, links to other functionalities such as scheduling components and an instant messaging module. Selectable controls may include textually and/or graphically represented controls for standard messaging operations as well as transaction processing-related operations such as paying an invoice, declining a money transfer or releasing funds to a recipient. User interface (500) may also include a pane for displaying a list of transactions pending process with their properties (in order of their due date, in order of their origination date, amount size, etc.).

According to some embodiments, transactions are associated within a conversation-type display using an “in-reply-to” relationship. Thus, a group of related transactions may be defined as the logical tree formed by a set of the replies, starting always with a single “new” received or sent transaction. Embodiments are not so limited, however. A conversation-type relationship between transactions may also be defined explicitly by a user (or administrator). Users may select transactions by a property (e.g. relationship ID), with any number of attributes, such as a color, a text, or a number. When a user sends out a transaction, he/she may explicitly set the relationship ID on the transaction (e.g. assign the transaction a specific relationship ID number). Any transactions that are subsequent actions related to the original transaction by other recipients may automatically carry the relationship ID, unless a recipient decides to change the property while processing the received transaction. User interface (500) may be configured to display relationships between the transactions or level of importance similarly using the principles described herein.

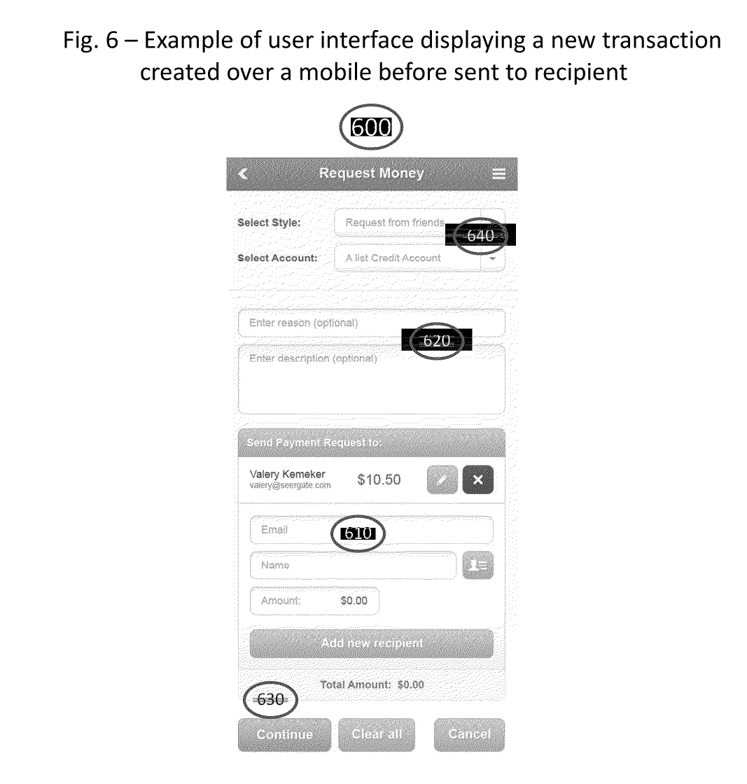

FIG. 6 illustrates a user interface according to embodiments of the present invention displaying a new transaction created over a mobile screen with the option to be sent to a recipient. Thus, user interface (600) includes most of the same elements of user interface (500) adapted to a smaller screen such as those of mobile devices, smartphones and tablets. FIG. 6 shows a new transaction created resembling the format of a new email created that has not yet been sent to the recipient. In the current example, the recipient area (610) resembles the “To” area of a regular email, the title or header and body area (620) includes what would be considered the subject and the body of an email message, and may include information more specific for financial transactions such as description of goods or services, quantities and amounts, and at the completion of the transaction information the user may chose to send (630) the transaction as a regular email is sent. The user may also be offered to chose a template (640) for the transaction as offered by certain email messaging systems.

Embodiments may be implemented using a variety of graphical, color, and shape schemes using the principles described herein, and are not limited to the example elements. Furthermore, the user interfaces may be configured differently than illustrated in the example figures.

1. A method to be executed at least in part in a computing device for providing a user interface that displays financial transactions as email messages, the method comprising: receiving, sending, forwarding and/or creating financial transactions within a user interface resembling a standard a email messaging user interface and/or an instant messaging user interface; determining the folder associated with the received, sent, forwarded and/or created transaction, wherein transactions created and sent are organized under the folder predefined for sent items, transactions received are organized under the folder predefined for received items, transactions cancelled or deleted are organized under the folder predefined for cancel and deleted items, all transactions can be accessed also under a general folder for all transactions, transactions that correspond to a search parameter are organized under the folder predefined for search results and transactions that comply with a manual or automatic created rule are organized under the predefined folder for said rule, the rule comprising a plurality of attributes and properties among the options presented in the user interface, such as Sender details, transaction number or ID, description key words, dates, level of importance and more. The method comprising a plurality of elements, presented in the user interface, determining the status, the level of importance and/or other attributes of a transaction, such as status icons besides the header or title of each transaction, different icon and/or header colors for example resembling debit/credit transactions using red/green colors, textual descriptors within the transaction body and/or on the header, such as completed/pending/canceled, and more. The method also comprising displaying the transactions within the user interface by presenting each transaction as an email message according to a selected or automatically generated order and within a mailbox folders structure resembling an email messaging interface visually, wherein each transaction includes a sender and recipient associated with the transaction, a header as a title, a time of creation and a time of status change and/or receipt, and a portion of body of the message that includes the transaction parameters such as transaction number or ID, reason, description and/or note, detailed information on the services and/or goods associated with the transaction, names, addresses and email addresses of the parties and more. The method also comprising that attributes and/or properties attributed to each transaction, such as title, status, level of importance, default folder, relationship to other transactions, processing rules such as due date, delayed processing and more, may be determined by applying automatic methods, or manually by the user, or alternatively by the originator of the initial transaction, or by an administrator with the option to set attributes and properties to transactions.

2. The method of claim 1, wherein the transactions are presented within each folder according to any of: a chronological order, sorted by senders or recipients names or emails in ascending or descending order, according to the transactions' amounts in ascending or descending order, according to transaction due date in ascending or descending order, sorted by status in any order, sorted according to a set of attributes and/or properties attributed to the transactions, organized manually by the user or by applying automatic rules that determine how transactions are organized.

3. The method of claim 1, wherein the header of each transaction is determined through at least one of: explicit definition and derivation from a subject line of the originating transaction, the reason included within the transaction text, the status of the transaction, the sender or recipient information or other transaction parameter.

4. The method of claim 1, wherein the level of importance of a given transaction is determined based on one of: user selection of a transaction parameter either by writing it within a field, user click, mouse-over or focusing of a cursor on a transaction parameter, automatic selection according to prior recurrence of a transaction, its amount or other parameter, and the level of importance is graphically presented with at least one of: a color scheme, a graphic scheme, an indentation scheme, a shading scheme, level icons.

5. The method of claim 1, wherein a relationship between transactions is determined automatically based on common characteristics such as sender and/or recipient, key words, amount, due date, or manually chosen by the user and such relationship is graphically presented with at least one of: a color scheme, a graphic scheme, an indentation scheme, a shading scheme, a graphic connector between the transactions.

6. The method of claim 5, wherein the graphical presentation of the relationship between transactions is used to provide additional information associated with at least one of: transaction parameters, transaction statuses, and relationship type.

7. The method of claim 1, wherein the graphic element used to indicate the transaction status includes at least one of the following: an icon, a color representing the transaction direction such as debit or credit from the user's account, an arrow to further represent the transaction direction, and a text descriptor of the status.

8. A computing device capable of executing an application for providing an user interface that displays transactions as email messages, the method comprising: receiving and/or creating and sending a new transaction within an electronic messaging mailbox interface, resembling a standard emailing interface; determining the folder associated with the received and/or created transaction, wherein transactions created and sent are organized under the folder predefined for sent items, transactions received are organized under the folder predefined for received items, transactions cancelled or deleted are organized under the folder predefined for cancel and deleted items, all transactions can be accessed also under a general folder for all transactions, transactions that correspond to a search parameter are organized under the folder predefined for search results and transactions that comply with a user created rule are organized under the user defined folder for said rule, the rule comprising a plurality of parameters selected by the user among the options presented in the user interface, such as Sender details, transaction number or ID, description key words, dates and more. The application also comprising a plurality of elements, presented in the user interface, determining the status of the transaction, such as status icons besides the header of each transaction, different icon and/or header colors resembling financial transaction statuses such as debit/credit transactions using red/green colors, status descriptor within the transaction and/or within the header, such as completed/pending/canceled, and more. The application also comprising displaying the transactions within the user interface by presenting each transaction as an email message according to a selected order and within a mailbox folders structure resembling an email messaging interface visually, wherein each transaction includes a sender and recipient associated with the message, a header as a title, a time of creation and a time of status change and/or receipt, and a portion of body of the message that includes the transaction parameters such as transaction number or ID, reason, description and/or note, detailed information on the services and/or goods associated with the transaction, names, addresses and email addresses of the parties and more.

9. The computing device of claim 8, wherein the transactions are presented within each folder according to any of: a chronological order, sorted by senders or recipients names or emails in ascending or descending order, according to the transactions' amounts in ascending or descending order, according to transaction due date in ascending or descending order, sorted by status in any order.

10. The computing device of claim 8, wherein the header of each transaction is determined through at least one of: explicit definition and derivation from a subject line of the originating transaction, the reason included within the transaction text, the status of the transaction, the sender or recipient information or other transaction parameter.

11. The computing device of claim 8, wherein the level of importance of a given transaction is determined based on one of: user selection of a transaction parameter either by writing it within a field, user click, mouse-over or focusing of a cursor on a transaction parameter, automatic selection according to prior recurrence of a transaction, its amount or other parameter, and the level of importance is graphically presented with at least one of: a color scheme, a graphic scheme, an indentation scheme, a shading scheme, level icons.

12. The computing device of claim 8, wherein a relationship between transactions is determined automatically based on common characteristics such as sender and/or recipient, key words, amount, due date, or manually chosen by the user and such relationship is graphically presented with at least one of: a color scheme, a graphic scheme, an indentation scheme, a shading scheme, a graphic connector between the transactions.

13. The computing device of claim 12, wherein the graphical presentation of the relationship between transactions is used to provide additional information associated with at least one of: transaction parameters, transaction statuses, and relationship type.

14. The computing device of claim 8, wherein the graphic element used to indicate the transaction status includes at least one of the following: an icon, a color representing the transaction direction such as debit or credit from the user's account, an arrow to further represent the transaction direction, and a text descriptor of the status.

15. A computer-readable storage device with instructions stored thereon for providing an user interface that displays transactions as email messages, the user interface comprising: receiving and/or creating and sending a new transaction within an electronic messaging mailbox interface, resembling a standard emailing interface; determining the folder associated with the received and/or created transaction, wherein transactions created and sent are organized under the folder predefined for sent items, transactions received are organized under the folder predefined for received items, transactions cancelled or deleted are organized under the folder predefined for cancel and deleted items, all transactions can be accessed also under a general folder for all transactions, transactions that correspond to a search parameter are organized under the folder predefined for search results and transactions that comply with a user created rule are organized under the user defined folder for said rule, the rule comprising a plurality of parameters selected by the user among the options presented in the user interface, such as Sender details, transaction number or ID, description key words, dates and more. The user interface also comprising a plurality of elements, presented in the user interface, determining the status of the transaction, such as status icons besides the header of each transaction, different icon and/or header colors resembling financial transaction statuses such as debit/credit transactions using red/green colors, status descriptor within the transaction and/or within the header, such as completed/pending/canceled, and more. The user interface also comprising displaying the transactions within the user interface by presenting each transaction as an email message according to a selected order and within a mailbox folders structure resembling an email messaging interface visually, wherein each transaction includes a sender and recipient associated with the message, a header as a title, a time of creation and a time of status change and/or receipt, and a portion of body of the message that includes the transaction parameters such as transaction number or ID, reason, description and/or note, detailed information on the services and/or goods associated with the transaction, names, addresses and email addresses of the parties and more.

16. The computer-readable storage device of claim 15, wherein the transactions are presented within each folder according to any of: a chronological order, sorted by senders or recipients names or emails in ascending or descending order, according to the transactions' amounts in ascending or descending order, according to transaction due date in ascending or descending order, sorted by status in any order.

17. The computer-readable storage device of claim 15, wherein the header of each transaction is determined through at least one of: explicit definition and derivation from a subject line of the originating transaction, the reason included within the transaction text, the status of the transaction, the sender or recipient information or other transaction parameter.

18. The computer-readable storage device of claim 15, wherein the level of importance of a given transaction is determined based on one of: user selection of a transaction parameter either by writing it within a field, user click, mouse-over or focusing of a cursor on a transaction parameter, automatic selection according to prior recurrence of a transaction, its amount or other parameter, and the level of importance is graphically presented with at least one of: a color scheme, a graphic scheme, an indentation scheme, a shading scheme, level icons.

19. The computer-readable storage device of claim 15, wherein a relationship between transactions is determined automatically based on common characteristics such as sender and/or recipient, key words, amount, due date, or manually chosen by the user and such relationship is graphically presented with at least one of: a color scheme, a graphic scheme, an indentation scheme, a shading scheme, a graphic connector between the transactions.

20. The computer-readable storage device of claim 19, wherein the graphical presentation of the relationship between transactions is used to provide additional information associated with at least one of: transaction parameters, transaction statuses, and relationship type.
